(19) United States
(12) Patent Application Publication
(10) Pub. No.: US 2014/0242836 A1
(43) Pub. Date: Aug. 28, 2014

(54) TERMINAL BLOCK WITH TWO FLANGES

(71) Applicants: Juergen Brand, Detmold (DE); Dennis Habirov, Bielefeld (DE)

(72) Inventors: Juergen Brand, Detmold (DE); Dennis Habirov, Bielefeld (DE)

(73) Assignee: PHOENIX CONTACT GMBH & CO. KG, Blomberg (DE)

(21) Appl. No.: 14/241,113

(22) PCT Filed: Aug. 27, 2012
(86) PCT No.: PCT/EP2012/003605

§ 371 Date: Feb. 26, 2014

(30) Foreign Application Priority Data
Sep. 2, 2011 (DE) 10 2011 112 120.3

(51) Int. Cl. H01R 13/50

(52) U.S. Cl. CPC H01R 13/50
USPC 439/569

(57) ABSTRACT

A terminal block includes at least one connecting terminal housing that extends in a longitudinal direction and is row-capable in a transverse direction. The transverse direction is transverse to the longitudinal direction. The connecting terminal housing includes a first flange and a second flange. The first flange is disposed in a first area at a first end of the connecting terminal housing and extends in a first direction. The second flange is disposed in a second area at a second end of the connecting terminal housing and extends in a second direction that is different than the first direction.

### CROSS-REFERENCE TO RELATED APPLICATIONS

This application is a U.S. National Phase application under 35 U.S.C. §371 of International Application No. PCT/EP2012/003605, filed on Aug. 27, 2012, and claims benefit to German Patent Application No. DE 10 2011 112 120.3, filed on Sep. 2, 2011. The International Application was published in German on Mar. 7, 2013 as WO 2013/029775 A1 under PCT Article 21 (2).

### FIELD

The present invention relates to a terminal block and flange terminal. Such terminal blocks or flange terminals are fixed, for example, to the surface of a mounting plate, but can also be mounted elsewhere.

### BACKGROUND

Various terminal blocks, which have flanges for mounting, have become known in prior art. For example, terminal blocks, which can be mounted using flanges and which can be arranged in series next to each other, have become known. At one end, a flange terminal, which is provided with a flange, is provided, to which single terminal blocks are attached until a cover plate is provided with a flange at the other end. The structure of such a terminal block requires more than one different component, namely on the one hand the flange terminal and on the other the terminal blocks without flanges and finally a cover plate with a flange.

Flange terminals have also become known where a central flange is provided on the housing, said flange being inserted into the housing of an adjacent flange terminal.

As well as the use as flange terminals, terminal blocks are also often mounted on top hat rails. No flanges are necessary for mounting them on top hat rails. It is, however, desirable in principle for an identical electrical construction to be provided for the different systems.

Terminal blocks are often required where a jumper link or cross bridge is possible in order to be able to set individual contacts of individual terminals to the same potential. In the process it should be possible to use a manufacturer-specific cross bridge since the development of special bridges as jumper links for individual connecting terminals is not worth it.

### SUMMARY

In an embodiment, the present invention provides a terminal block that includes at least one connecting terminal housing that extends in a longitudinal direction and is row-capable in a transverse direction. The transverse direction is transverse to the longitudinal direction. The connecting terminal housing includes a first flange and a second flange. The first flange is disposed in a first area at a first end of the connecting terminal housing and extends in a first direction. The second flange is disposed in a second area at a second end of the connecting terminal housing and extends in a second direction that is different than the first direction.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a plan view of a terminal block according to the invention with three connecting terminal housings;

FIG. 2 shows a plan view of an individual terminal block according to the invention;

FIG. 3 shows a side view of the terminal block according to FIG. 2;

FIG. 4 shows a perspective view of the terminal block according to FIG. 2;

FIG. 5 shows a view of the terminal block from FIG. 1 from below;

FIG. 6 shows a section through the terminal block according to FIG. 1.

### DETAILED DESCRIPTION

It is an aspect of the present invention to provide a terminal block, which is accomplished using fewer different components and which is preferably suitable for a cross bridge.

The terminal block according to the invention has many advantages. A considerable advantage of the terminal block according to the invention is achieved in that the first flange and the second flange extend in different directions. The first flange and the second flange do not extend along a common axis but rather in different directions. Thus the provision of a cross bridge is facilitated simply. Apart from this, the construction of a terminal block with a plurality of connecting terminal housings with fewer components overall is facilitated since only two components now have to be used, namely a connecting terminal housing and a cover plate to complete the connecting terminal housing. The cover plate does not need to have a flange.

A plurality of connecting terminal housings can be arranged next to each other in series, possibly only one cover plate being necessary.

The cover plate can also be used in top hat mountable modular terminal blocks.

The terminal block according to the invention can be constructed as a mini-flange terminal and is particularly row-capable and to this extent can also be described as a modular terminal block.

In a preferred development, at least one insertion opening is provided for a cross bridge. In particular, the insertion opening is provided in a central area of the connecting terminal housing. Thus the insertion opening for the cross bridge is arranged between the first flange and the second flange so that the flanges cannot prevent the insertion of a bridge or restrict the dimensions of the bridge.

In preferred embodiments, at least the first flange is arranged at an angle to the connecting terminal housing. Preferably or alternatively, the second flange can also be arranged at an angle to the connecting terminal housing. Particularly preferably, the first flange and the second flange can each be arranged at an angle to the connecting terminal housing. Particularly preferably, at least one first and/or second flange extends approximately transverse to the connecting terminal housing.

In principle, an angle between the extensions of the first and/or second flange to the longitudinal extension of a connecting terminal housing can be of any size. In the case of angled flanges, the angle is preferably greater than 30 degrees and is in particular between 60 and 150 degrees. Particularly preferably, at least one flange extends approximately at right angles to the longitudinal extension of the connecting terminal housing.

It is possible and preferable for a flange of a first connecting terminal housing to extend to below an adjacent second connecting terminal housing in the assembled state. In the process, it is possible for the flange of the one connecting terminal housing to extend into the flange of the adjacent connecting terminal housing.

Preferably, the second direction is aligned opposite to the first direction. In the process, the first flange is preferably arranged in a plane, which is approximately parallel to the plane in which the second flange is arranged.

In particularly preferable embodiments, the first and second flanges are arranged substantially point symmetrically to the connecting terminal housing. This means that, viewed roughly, a somewhat S-shaped form of a connecting terminal housing emerges, one flange extending outwards from the connecting terminal housing at each respective end of the connecting terminal housing.

A point symmetrical configuration is advantageous since it facilitates a simple and clearly arranged construction and allows the use of identical parts, which can be inserted into the interior of the terminal block.

The connecting terminal housing is preferably constructed such that it is closed on one side while it is accessible from the other side. The open side is either covered by an adjacent connecting terminal housing or alternatively closed by a cover plate, for example. In the process, the cover plate can be constructed of one part or alternatively consist of more than one individual part.

Particularly preferably, one lateral width of the first flange is larger than a transverse extension of the connecting terminal housing. The transverse extension of the connecting terminal housing is particularly also smaller than a lateral width of the second flange. Preferably, the lateral widths of the first and second flanges are the same. Due to the smaller transverse extension of the connecting terminal housing, an altogether small terminal block is provided.

In preferable developments, a plurality of connecting terminal housings are arranged in series next to each other and a flange of a connecting terminal housing is inserted into the corresponding flange of an adjacent connecting terminal housing. Due to such a configuration, a compact terminal block is provided, which can have a large number of connecting terminal housings.

Preferably, at least one first and/or second flange has at least one chamfer on a front and/or lateral end of the flange.

Particularly preferably, the first flange and/or the second flange is provided with at least one guide groove. In the process, it is particularly preferable for the guide groove to interact with a guide contour on an adjacent flange. For this purpose, at least one guide contour is provided on at least a first and/or second flange. When the connecting terminals are pushed together, the guide contours engage in the corresponding guide grooves and bring about a self-centering and alignment of the terminal block.

Overall the terminal block according to the invention facilitates the construction of one such that has a lower number of different parts. In the process, the construction of mini flange terminals, which can be arranged in series next to each other and where the use of a cross bridge is possible, is facilitated.

In the process, the use of standard bridges, which are inserted deep into the terminal block in a central area of the connecting terminal housing, is possible. Because the flanges are not provided in a central area of the connecting terminal housing, but rather at the ends of the connecting terminal housing, the full construction height is available in a central area of the connecting terminal housing, in which the standard bridges can be pushed as jumper links.

Because the terminal block can have guide grooves and guide contours, a firm and precisely defined retention of the terminal block is facilitated overall. Furthermore, locking via locking pins and locking holes is possible.

The same cover plates that are also used in the case of such terminal blocks on top hat rails can be used as cover plates. Because essentially the same electrical structures are used and the terminal blocks only differ in that they are either mounted via flanges or via a top hat rail; cover plates, which are provided for mounting on terminal blocks for top hat rails, can also be used in the case of the terminal block according to the invention. Thus the diversity of parts is again reduced overall, thus enabling cheaper production.

Other advantages and features of the present invention will emerge from the description of the embodiment.

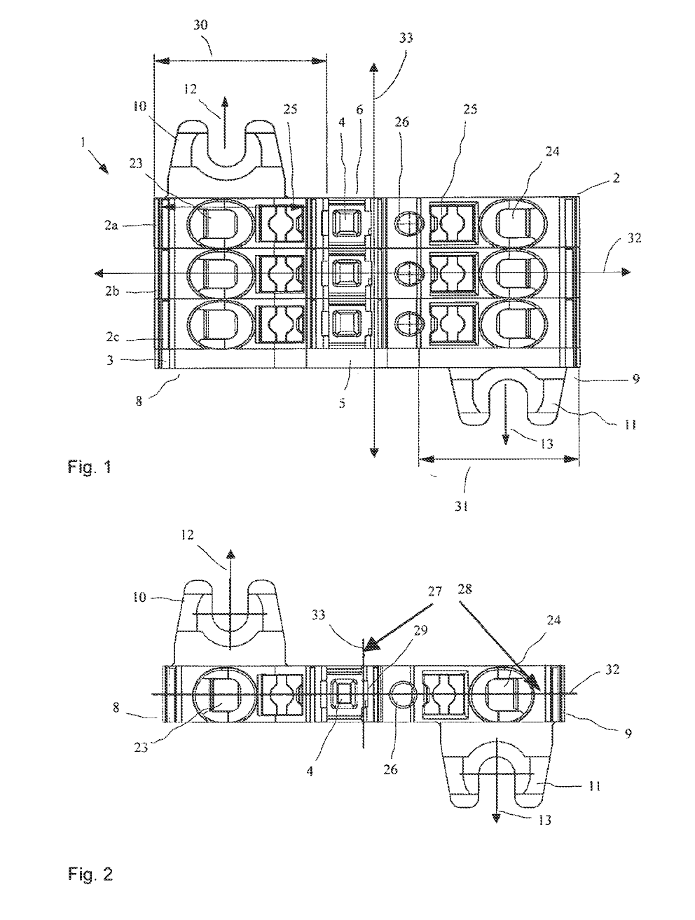

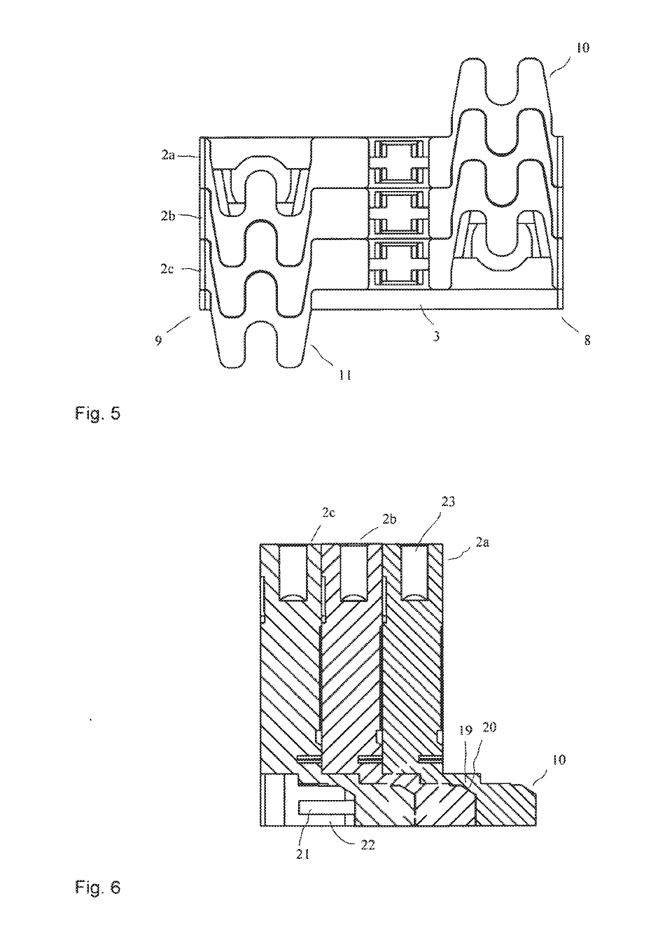

With reference to the accompanying FIGS. 1 to 6, an embodiment of a terminal block 1 according to the invention is described hereinafter. In the process, FIG. 1 shows a plan view of a terminal block 1, which consists of three connecting terminal housings 2a, 2b and 2c arranged in series next to each other. FIG. 2 shows an individual terminal block.

Each individual terminal block 1 from FIG. 1 has a first flange 10 and a second flange 11, which extend away from the connecting terminal housing at the first end 8 and the second end 9 respectively. In the process, the first flange 10 extends in a first direction 12 and the second flange 11 extends in a second direction 13. The first direction 12 and the second direction 13 are parallel offset here and aligned in opposite directions so that in the plan view of the individual connecting terminal according to FIG. 2, there emerges a roughly S-shaped form.

Each individual connecting terminal housing 2a, 2b and 2c has contact openings 23 and 24 and here also an insertion opening 4 for a cross bridge 5. Furthermore, a test hole 26 for a test plug is provided.

Both the test hole 26 for the test plug and the insertion openings 4 for a cross bridge 5 are provided in a central area 6 of the respective connecting terminal housing 2a, 2b and 2c. In the process, the insertion openings 4 for a cross bridge 5 are arranged between the first flange 10 and the second flange 11, viewed in a longitudinal direction of a connecting terminal housing 2a.

It is thus made possible for a flange 10 of a connecting terminal housing 2c to extend through beneath an adjacent connecting terminal housing 2b, so that each individual connecting terminal housing 2a, 2b, and 2c can each be provided with two flanges 10 and 11.

At the same time, standard bridges can be used for a cross bridge 5, without the flanges 10, 11 being disturbed by the use of the bridges. The construction of special cross bridges is not necessary because the jumper links also used with other flanges can be inserted here.

A break contact 25 can be provided at each of the contact openings 23 and 24.

The terminal block 1 from FIG. 1 has three connecting terminal housings 2a, 2b and 2c, a cover plate 3 only connecting to connecting terminal housing 2c.

The terminal block 1 consists here of three connecting terminal housings 2, or 2a, 2b and 2c, arranged in series next to each other. Each connecting terminal housing 2a, 2b and 2c extends in the longitudinal direction 32. The connecting terminal housings 2a to 2c are arranged in series next to each other in the transverse direction 33 transverse to the longitudinal direction 32. The longitudinal direction 32 can be aligned perpendicular to the transverse direction, but can also be at a different angle. For example, angles of between 30° and 150° are preferable. In particular, however, there is a substantially right angle of between 80° and 100° and preferably between 85° and 95°.

Viewed in the longitudinal direction 32, a first flange 10 extends in a first area 30 at a first end 8 of the connecting terminal housing 2 (or 2a to 2c respectively) in a first direction. The first flange 10 can be arranged precisely at the first end 8, but can also be at a considerable distance therefrom.

Viewed in the longitudinal direction 32, a second flange 11 extends in a second area 31 at the second end 9 of the connecting terminal housing 2 (or 2a to 2c respectively) in a second direction 13 that is different from the first direction 12. The second flange 11 can also be arranged precisely at the second end 9, but can also be at a considerable distance therefrom.

Overall, a connecting terminal housing 2 can be divided into three areas in the longitudinal direction 32: the first area 30 at a first end 8, the second area 31 at a second end and the (or at least one) central area 6 between them.

FIG. 2 shows an individual connecting terminal housing, it becoming clear again that on each individual connecting terminal housing 2a, 2b and 2c two flanges 10 and 11 are provided, which extend in different directions at an angle to the connecting terminal housing. In FIG. 2, two axes of symmetry 27 and 28 are drawn, which lead to a point of symmetry 29 in relation to the flanges, so that point symmetry of the terminal block 1 emerges in relation to the flanges 10, 11.

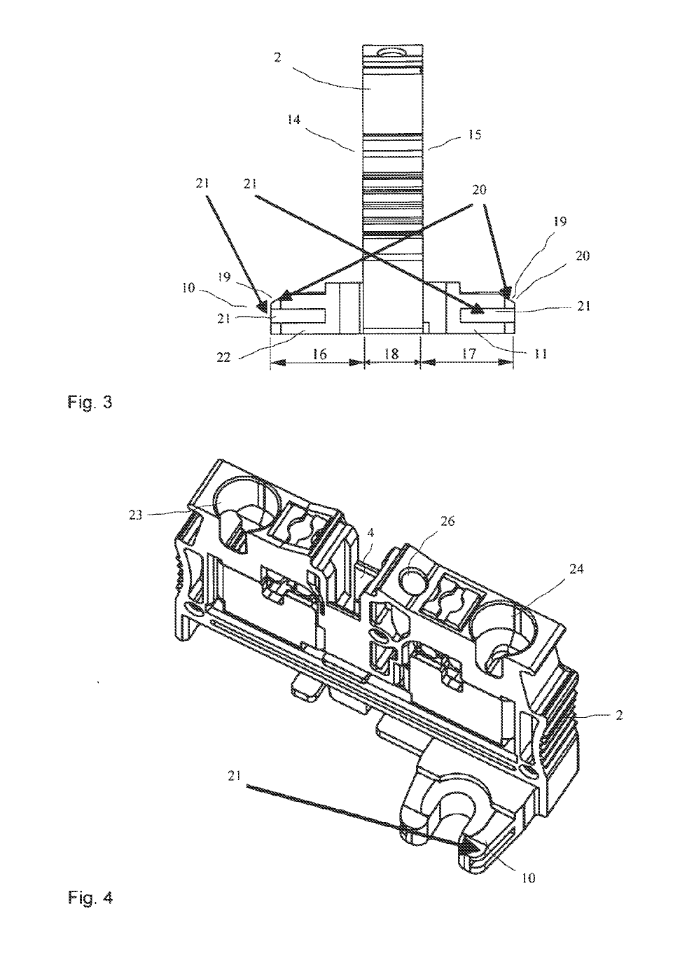

FIG. 3 shows a side view of the terminal block 1 from FIG. 2. It can be seen clearly that the flange 10 extends in the first direction 12 on one side 14 of the connecting terminal housing while the second flange 11 is on the other side 15 of the connecting terminal housing 2.

While the connecting terminal housing 2 is constructed such that it is closed on one side 14, the interior of the connecting terminal housing 2 on the other side 15 is constructed such that it is open.

A lateral width 16 of the flange 10 is equivalent to a lateral width 17 of the flange 11. Both the lateral width 16 and the lateral width 17 of the flanges 10 and 11 are larger than a transverse extension 18 of the connecting terminal housing 2.

On the sides and/or ends 20 of the flanges 10, 11, guide grooves 21 and guide contours 22 are provided, so that the individual flanges 10, 11 engage with each other precisely, and are guided into each other on insertion.

At the front ends 20 of the flanges 10 and 11, the upper part of the flanges 10 or 11 is provided with a chamfer 19 in order make insertion easier. In addition, the stability of the housing is increased.

Thus the required wall thickness in the construction of the flanges is secured, so that adequate stability and a firm fit of a plurality of connecting terminal housings next to each other emerges.

Overall, the invention provides an advantageous terminal block 1, which can be constructed as a modular terminal block and has flanges for mounting. The use of a jumper link is possible, it being possible to use a standard bridge, since the fixing flanges are provided on the ends of the connecting terminal housing 2.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

1 Terminal block
2, 2a, 2b, 2c Connecting terminal housing
3 Cover plate
4 Insertion opening
5 Cross bridge
6 Central area
8 First end
9 Second end
10 First flange
11 Second flange
12 First direction
13 Second direction
14 One side
15 Other side
16, 17 Lateral width
18 Transverse extension
19 Chamfer
20 Front end
21 Guide groove
22 Guide contour
23, 24 Contact opening
25 Break contact
26 Test hole for test plug
27, 28 Axis of symmetry
29 Point of symmetry
30 First area
31 Second area
32 Longitudinal direction
33 Transverse direction

1-13. (canceled)

14. A terminal block comprising:
at least one connecting terminal housing extending in a longitudinal direction and row-capable in a transverse direction that is transverse to the longitudinal direction, the at least one connecting terminal housing comprising:
a first flange disposed in a first area at a first end of the connecting terminal housing and extending in a first direction; and
a second flange disposed in a second area at a second end of the connecting terminal housing and extending in a second direction that is different from the first direction.

15. The terminal block recited in claim 14, wherein the connecting terminal housing has at least one insertion opening adapted to receive a cross bridge.

16. The terminal block recited in claim 15, wherein the insertion opening is disposed in a central area of the connecting terminal housing.

17. The terminal block recited in claim 14, wherein at least one of the first flange or the second flange is arranged at an angle to the connecting terminal housing.

18. The terminal block recited in claim 14, wherein the second direction is aligned opposite to the first direction.

19. The terminal block recited in claim 14, wherein the first flange and the second flange are arranged substantially point symmetrically to the connecting terminal housing.

20. The terminal block recited in claim 14, wherein the connecting terminal housing is closed on one side.

21. The terminal block recited in claim 14, wherein at least one of a lateral width of the first flange or a lateral width of the second flange is larger than a transverse extension of the connecting terminal housing.

22. A terminal block comprising:
a plurality of connecting terminal housings arranged in series next to each other, the plurality of connecting terminal housings extending in a longitudinal direction and row. capable in a transverse direction that is transverse to the longitudinal direction, each of the connecting terminal housings comprising:
a first flange disposed in a first area at a first end of the connecting terminal housing and extending in a first direction; and
a second flange disposed in a second area at a second end of the connecting terminal housing and extending in a second direction that is different from the first direction;
wherein the first or second flange of a first connecting terminal housing is inserted into the corresponding first or second flange of an adjacent connecting terminal housing.

23. The terminal block recited in claim 22, wherein at least one of the first flange or the second flange includes at least one chamfer at a front end.

24. The terminal block recited in claim 22, wherein at least one of the first flange or the second flange includes at least one guide groove.

25. The terminal block recited in claim 22, wherein at least one of the first flange or the second flange includes at least one guide contour.

26. The terminal block recited in claim 22 further comprising at least one cover plate.
